(19) United States
(12) Patent Application Publication
(10) Pub. No.: US 2002/0191851 A1
(43) Pub. Date: Dec. 19, 2002

(54) Efficient encoding of video frames using pre-encoded primitives

(76) Inventor: Giora Keinan, Rishon LeZion (IL)

Correspondence Address: SALTAMAR INNOVATIONS, 30 FERN LANE, SOUTH PORTLAND, ME, 04106, US

(21) Appl. No.: 10/127,251

(22) Filed: Apr. 22, 2002

Related U.S. Application Data
(60) Provisional application No. 60/288,150, filed on May 1, 2001.

(51) Int. Cl. G06K 9/36

(52) U.S. Cl. 382/232

(57) ABSTRACT

A method for efficient encoding of video frames by pre-encoding image primitives such as text, pictures, icons, symbols and the like, and storing the pre-encoded primitive data. When a video frame needs to be encoded, portions of it that correspond to pre-encoded primitives are identified, and the pre-encoded primitives data are sent to the output stream, thus saving the need to repeatedly re-encode the primitive portion.

This application claims the benefit of priority to a U.S. provisional patent application No. 60/288,150 filed May 1, 2001, which is hereby incorporated by reference.

### FIELD OF THE INVENTION

The invention relates generally to methods of encoding video, and more particularly to methods of encoding video using pre-encoded components of the video data.

### BACKGROUND

MPEG2 (Moving Pictures Expert Group) encoding was developed in order to compress and transmit video and audio signals. It is an operation that requires significant processing power.

The general subject matter and algorithm for encoding and decoding MPEG2 frames can be found in the MPEG standard (13818-2 Information technology—Generic coding of moving pictures and associated audio information: video published by the International Standard Organization ISO/IEC, incorporated herein by reference) and in the literature. The basic stages for encoding an ‘I’ type frame are described bellow:

Converting the image to YUV (Luminance, hue, and saturation color space).

Performing DCT (Discrete Cosine Transform) transformation.

Performing Quantization

Scanning (zigzag or alternate)

Encoding in Huffman code or in run-length-limited (RLL) encoding.

The standard allows the first stage to be performed on blocks or on a full frame. All subsequent stages are to be performed on 8×8 pixels blocks. The result of the last stage is the video data that is transmitted or stored.

Several attempts have been made to reduce the computing requirement associated with MPEG 2 encoding. U.S. Pat. No. 6,332,002 to Lim et al. teaches a hierarchical algorithm to predict motion of a single pixel and half pixel for reducing the calculation amount for MPEG2 encoding. Car et al. proposed a method for optimising field-frame prediction error calculation method in U.S. Pat. No. 6,081,622. However those methods deal primarily with frame-to-frame differences.

It is clear from the above that there is a significant advantage, and heretofore-unresolved need for reducing the high processing power required for encoding video, most specifically using MPEG2. Thus the present invention comes to increase the efficiency of the encoding process in term of required computer power and encoding time.

### BRIEF DESCRIPTION

At the base of the present invention is a unique realization: When a large portion of the frame is known, either if it generated by a computer, in animation, or generally if certain areas on the screen consist of known graphics, significant additional efficiency may be gained. This gain may be realized by pre-encoding primitives—portion of the desired image—and utilizing the pre-encoded primitives to encode a frame or a part of a frame. This seemingly counter-intuitive concept integrates the conventional ‘moving picture’ concept inherent to video, with the efficient concept of encoding a still picture only once.

The new encoding method is especially suitable to encoding still frames, where parts of those frames comprise known graphic primitives. In the encoding procedure a set of known graphic primitives are combined in the encoded stream with unknown parts—if any—and transmitted to the network, or stored.

Thus in the preferred embodiment of the invention there is provided a method comprising the steps of pre encoding graphic primitives into a pre-encoded data store. When a source video frame needs to be transmitted, determining portions thereof which correspond to pre-encoded primitives, and encoding the source frame into an output video stream, and merging pre-encoded primitive data from the pre-encoded data store into said output video stream, as dictated by the step of determining.

In cases where changes between the frames are known prior to transmission, a similar method can be used in order to generate P and B type frames.

As mentioned above, the method operates best in a system where parts of the encoded frames are built from previously known graphic primitives. This knowledge is used in order to encode the required frames in an efficient way. Examples of such primitive include company logos, icons, characters, often repeated words and sentences, portions of or complete images, and the like. This method is especially effective in a ‘walled garden environment’, i.e. where a service provider sets a limited, primarily known environment for its users.

Preferably, the primitives are stored in pre-encoded storage, which may be any convenient computer storage such as disk drive, memory, and the like.

If the source frame is generated by a computer, the computer may generate only a list of primitives to be merged with indication of the proper location of such primitives in the frame. Thus for example if a frame is a representation of computer generated image containing text, the text or portions thereof may be replaced by pointers to the pre-encoded primitive data, either by the computer or by the encoding device. However in the case of live video, as well as computer generated frames, and in various combinations thereof, the invention preferably comprises the step of making a list of pre-encoded primitives if such list is needed, and then utilizing the list during the encoding process to merge the primitives as indicated by the list. If a list is created, the determining process may be carried out discreetly from the encoding process, e.g. by another processor or at a different time than the encoding time. Clearly, a computer generated screen may consist only of text, and can be transformed to video by merging pre-encoded primitives according to the supplied text.

In certain cases the step of generating the list above may be avoided by analysing the video frame or the source data of the video frame during the video frame encoding. Similarly, placeholders or pointers may be placed within the frame data to indicate primitive replacement.

Other primitives that have not been pre encoded, equivalently referred to as dynamic primitives or regions, may also be merged into the output stream as required.

Therefore an aspect of the invention provides a method for efficient encoding of video frames comprising the steps of pre-encoding graphic primitives into a pre-encoded data store; and encoding said source video frame or a portion thereof into an output video stream, and merging said pre-encoded primitive data from said pre-encoded data store into said output video stream. Optionally, the steps also include generating a list (preferably using a computer) comprising indications of pre-encoded primitives and relative location of said primitive within a source video frame; where the merging is done as dictated by said list. This process also allows for merging dynamic primitives or regions as required.

According to the preferred embodiment of the invention the pre-encoding stage occurs prior to the encoding stages of merging the pre-encoded data in the frame.

According to the most preferred embodiment of the invention, there is provided a method for efficient encoding of computer generated video frames comprising the steps of:

Pre-encoding graphic primitives into a pre-encoded data store, said pre-encoded data store comprising a plurality of macro blocks representing one or more pre-encoded primitives;

Generating a source video frame comprising a list of pre-encoded primitives and relative locations thereof within the source video frame;

Encoding said source video frame or a portion thereof into an output video stream said step of encoding comprises:

Mapping of macro blocks, representing selected pre-encoded primitive data, into a macro block map;

Merging a plurality of pre-encoded macro blocks data from said pre-encoded data store, into an output video stream, as dictated by said macro block map.

Optionally, the invention further provides the steps of encoding dynamic regions of said source video frame into encoded dynamic data; and merging said encoded dynamic data and said pre-encoded macro blocks into said output stream. In such embodiment, the invention further provides the option of performing the step of mapping and the step of encoding the dynamic regions simultaneously.

It should be noted that the term ‘source video frame’ relates primarily to any representation of the video frame to be encoded. Thus the source video frame may by way of example, comprise only a list of pre-encoded primitives, a list of pre-encoded primitives combined with dynamic primitives, an actual video format frame or a representation that may be readily transformed to video format.

### SHORT DESCRIPTION OF THE DRAWINGS

In order to aid in understanding various aspects of the present invention, the following drawings are provided:

FIG. 1 depicts a simplified block diagram of the pre-encoding process in accordance with a preferred embodiment of the invention.

FIG. 2 shows an example block diagram of an encoding process according to a preferred embodiment of the invention.

FIG. 3 shows an example of a frame divided into pre-encoded and dynamic regions.

FIG. 4 depicts a simplified block diagram of an encoding process according to a preferred embodiment of the invention.

FIGS. 5 and 6 depict a macro block mapping example.

FIG. 7 depicts an example of a graphic primitive list for encoding.

FIG. 8 depicts an example of graphic primitives encoded storage.

FIG. 9 depicts and example of a macro block map.

FIG. 10 depicts an example of output data.

### DETAILED DESCRIPTION

Pre-encoding Stage.

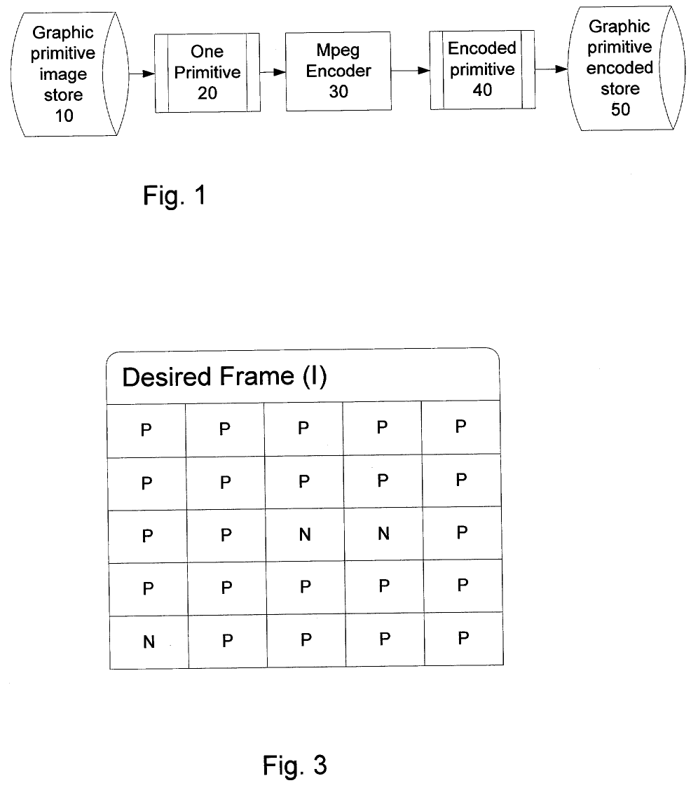

An important aspect of the invention revolves a round pre-encoding of macro-blocks representing known graphic primitives, and storing the pre-encoded data for later use. FIG. 1 is a schematic representation of one embodiment of this pre-encoding stage.

In the preferred embodiment of this stage known primitives, e.g. text characters or phrases, symbols, logos and other graphics, are stored in graphic primitive images storage 10. Primitives 20 are taken from storage 10 and encoded by the MPEG encoder 30. The result—the encoded primitive 40 is than stored in the graphic primitive encoded store 50. Each encoded object contains the macro blocks and their relative positions. The system repeats the encoding process for as many graphic primitives as desired.

Run Time Encoding Stage.

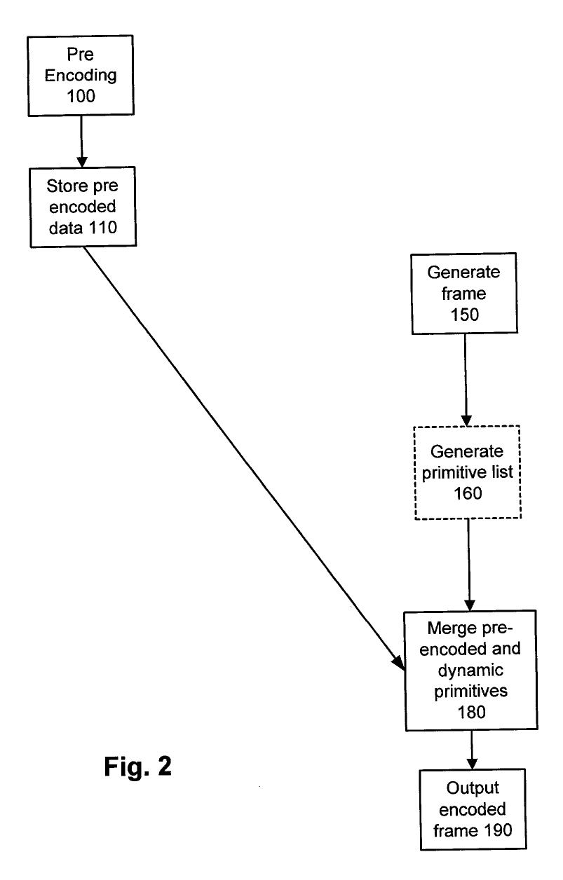

FIG. 2 presents a schematic representation of an encoding stage according to the preferred method.

After the pre-encoding 100 and storage of the pre-encoded primitives 110, which may be carried out on a different machine, or at a different time (or both), the encoding process begin when a video frame to be encoded is generated 150. The frame may comprise dynamic and pre-encoded primitives. A primitive list is generated 160 and primitives are merged into the frame data 180. The merged data is than outputted 190 as the encoded frame, preferably directly to a transport stream. More preferably, the frame is being generated with an already prepared accompanying list of primitives. The list generation stage may happen at any time after the desired video frame is known, or even when the relative position of a primitive is known. The order in the drawing represents merely one possible order of execution. Clearly the list may be divided into a plurality of lists, and any convenient data may be employed for creating and maintaining such a list, without detracting from the invention. Optionally, the list may comprise pointers to primitive data. In yet another embodiment, the list comprises pointers to data blocks such as macro blocks, comprising the pre-encoded primitives.

Oftentimes such computer generated screens or pre-compiled information screens need to mix the information with ‘live’ information (information that have not been pre-encoded). The live information is referred to as dynamic, but may comprise any type of data that has not been pre-encoded, such as graphics, animation (which may comprise a dynamic, pre-encoded primitives, or a combination thereof live video, text messages, and the like.

For simplicity, in the following paragraphs the description will concentrate on computer generated images, where a software application generates the desired screen. It is noted that other types of images, such as pre compiled images, split or overlapping screens, and the like are also suitable for the invention and their implementation will be clear to those skilled in the art in light of these specifications.

FIG. 3 shows a desired frame that combines pre-prepared primitives marked P, and new dynamic regions, unknown at pre-prepare stage—marked N.

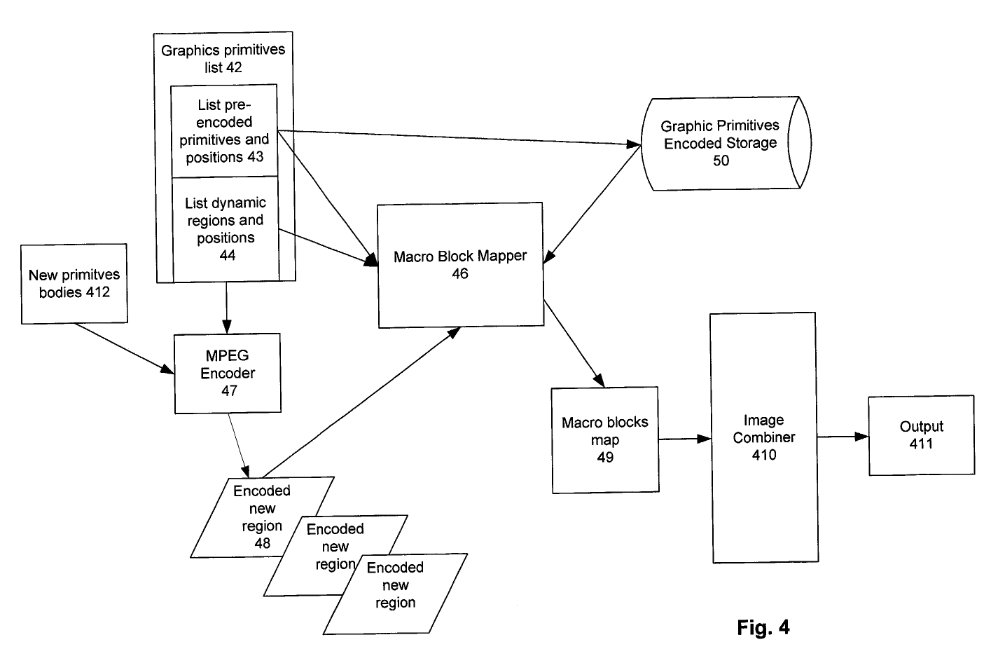

In FIG. 4, an application that generates video frames transfers these frames as a set of known, pre-compressed graphic primitives 43 and a set of new, not pre-compressed primitive bodies 412 equivalently referred to in these specifications as ‘dynamic’ or ‘unknown’ primitives. A primitive, whether known or unknown, that is associated with positioning information within the frame, is occupying a ‘region’ within the frame. The terms ‘primitive’ and ‘region’ are used interchangeably.

The graphic primitives list 42 can be separated into two lists: a list of the known 43 and unknown, or dynamic 44 regions. The dynamic regions are encoded by the encoder 47 and stored as one or more encoded new regions 48. The macro-block mapper 46 uses the graphic primitives list 42, the encoded new region 48, and the Graphic primitive encoded storage 50 in order to generate a macro-block map 49. This map contains the list of the macro-blocks in the image, or pointers thereto. The map may even contain the macro blocks data itself if desired. The image combiner 410 uses the map 49, the encoded new regions 48 and the Graphic primitive encoded storage 50 in order to generate the output 411. The image combiner copies the macro blocks to the output according to the order mapped in the macro blocks map.

In order to prevent distortions and artefacts in the picture, the preferable embodiment calls for placing the pre-encoded primitives within slices. MPEG 2 supports “Slices”, which are elements to support random access within a picture. In MPEG 2, generally a macro block uses the DC coefficients of the block primitive, or in some cases during the transition between one pre-encoded. During a transition between a dynamic object and a pre-encoded primitive and the next, it is desirable to have the macro block recalculate the DC coefficients based on its own data. Thus a slice header is entered in the output stream before the beginning of a pre-encoded primitive or a group of such primitives. Optionally, such header may be entered when the primitive data ends as well if a dynamic region is to continue on the same line.

In case of P frames the operation described above need only be performed on the differences between the previous and the current frame.

Additional embodiments of the invention may also utilize encoding the new regions on the fly or in parallel. In this implementation the dynamic regions are encoded in parallel to the macro block mapping in order to make the process faster.

In another embodiment of the invention the application is processing the primitives sequentially without the use of a graphic primitives list.

Similarly, the use of the macro block map 49 may be avoided if desired by having the image combiner 410 works directly with lists 42, 43, and 44, and the lists are constructed to provide the macro-blocks in the correct position.

Detailed Macro Block Mapping Example.

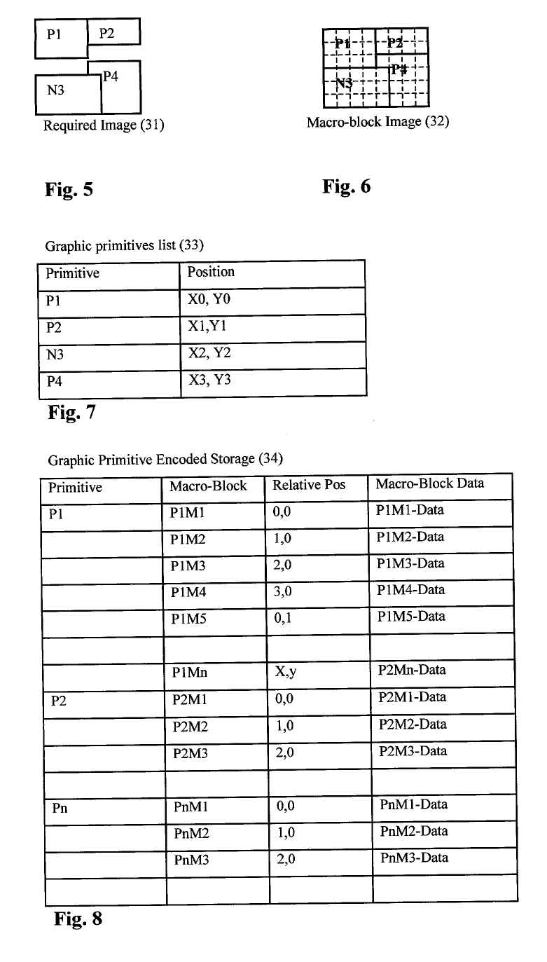

An example of macro-block mapping is depicted in FIGS. 5 and 6. For clarity only a part of the Frame is discussed. The required image is build from four graphic regions as shown in (31), three of them are pre encoded primitive (p1,p2, p4) and one new, dynamic region (n3). The macro blocks corresponding to this image are shown in the macro-block image (32). The encoder receives the list of the primitives (33) as shown in FIG. 7.

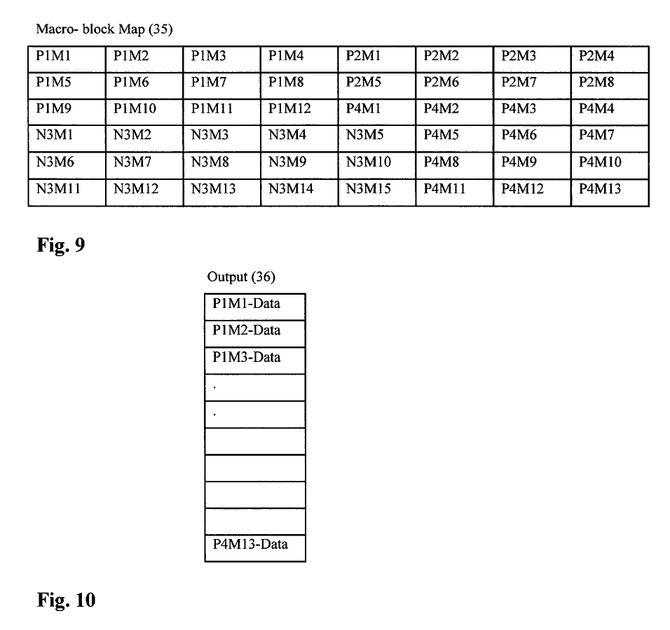

The graphic primitive encoded storage 34 shown in FIG. 8, stores the pre-encoded data with the following parameters: the primitive reference, the Macro-blocks of this primitive, the relative position of the macro block within the primitive, and the macro block data (compressed video). The list of the new-encoded data has a similar format (not shown in this diagram). The Macro—block Mapper 49 traverses the list 33 (FIG. 7) and for every primitive puts every macro-block or a pointer to every macro block in the correct position in the macro-block map 35 (FIG. 9). The Image Combiner 410 goes over the map and copies the macro-block data from the graphic primitive encoded storage 34, (FIG. 8) to the output 36 (FIG. 10).

In addition to the clear advantages the present invention offers any application were portions of the screen are known in advance, the invention is directly applicable to other operations, including by way of example:

Animation: the method can be used for creating animated motions from pre defined character movements. In this application, encoded pre-define movements are stored. The application then sends for each frame or a group of frames, a list of primitives that in this case represents the animated object position.

Use for generating banners (for example a station logo) in motion pictures. In this application, part of the screen is a primitive that is pre-encoded and mixed with live video.

Similarly it will be clear the invention described herein is applicable, and enables those skilled in the art, to apply the invention to other video encoding standards other than MPEG-2 which is used herein by way of example.

The modification examples portrayed herein, and the use examples presented, are but a small selection of numerous modifications and uses clear to the person skilled in the art. Thus the invention is directed towards those equivalent and obvious modifications variations, and uses thereof.

Required Run Time Calculations/Operations

By way of example of the advantages offered by the preferred embodiment of the invention, table 1 below provides a comparison, by presenting estimated numbers of computer operations required to present a sample video frame utilizing the conventional method of encoding as compared to the number of operations the present invention enables. For the sake of simplicity, control operations were not calculated.

Notes and Assumptions:

The pre-encoded calculation was done on a known frame.

The macro copying was calculated as one copy operation (memcpy or similar). Calculation of copying byte by byte will add about 20000 operations.

The YUV sub-sampling considered is 4:2:0.

The 0.5 N represents the results of ¼ sub sampling of the U and V multiplied by 2 (U and V).

TABLE 1

| | | Computing |
|---|---|---|
| Description | Quantity | operations |
| Image Height | 480 | |
| Image Width | 640 | |
| Num of pixels (N) | 307200 | |
| Num of blocks (B) | 4800 | |
| Num of Macro blocks (M) | 1200 | |
| Num of Primitives (P) | 1000 | |
| Convert the image to YUV. | N * (3 * 3 * 3 + 8) | 10752000 |
| DCT (Discrete Cosine | (N + 0.5 N) * 4 | 1843200 |
| Transform). | | |
| Quantization | (N + 0.5 N) | 460800 |
| Scanning (zigzag or alternate) | (N + 0.5 N) | 460800 |
| Huffman code/running length | (N + 0.5 N) (1 + log(N)) | 921600 |
| Total conventional encoding | | 14438400 |
| Sorting the primitives | P(1 + log(P)) | 10966 |
| Macro positioning | P + M | 2200 |
| Macro Copying | M | 1200 |
| Total pre-encoding | | 14366 |

I claim:

1. A method for efficient encoding of computer generated video frames, comprising the steps of:
pre-encoding graphic primitives into a pre-encoded data store, said pre-encoded data store comprising a plurality of macro blocks representing one or more pre-encoded primitives;
generating a source video frame comprising a list of pre-encoded primitives and relative locations thereof within the source video frame;
encoding said source video frame or a portion thereof into an output video stream;
said step of encoding comprises:
mapping of blocks or references thereto, representing selected pre-encoded primitive data, into a macro block map;
merging a plurality of pre-encoded blocks data from said pre-encoded data store, into an output video stream, as dictated by said macro block map.

2. A method according to claim 1, further comprising the steps of:
encoding dynamic regions of said source video frame into encoded dynamic data; and,
merging said encoded dynamic data and said pre-encoded blocks into said output stream.

3. The method according to claim 2 wherein said step of encoding dynamic regions and said step of mapping are performed simultaneously.

4. The method according to claim 1, wherein at least one of said graphic primitives comprises a text character.

5. The method according to claim 1 wherein said list is embedded within said source video frame.

6. The method according to claim 1 wherein said output video stream comprises an MPEG-2 stream.

7. The method according to claim 1 wherein said list comprises pointers embedded within the source video frame data.

8. A method for efficient encoding of video frames comprising the steps of:
pre-encoding graphic primitives into a pre-encoded data store;
using a computer, generating a list comprising indications of pre-encoded primitives and relative location of said primitive within a source video frame;
encoding said source video frame or a portion thereof into an output video stream;
wherein said step of encoding comprises the step of merging said pre-encoded primitive data into said output video stream, as dictated by said list.

9. The method according to claim 8 wherein said step of merging further comprises encoding and merging of dynamic regions into said output stream.

10. The method according to claim 8 wherein said graphics primitive comprise text characters.

11. The method according to claim 8 wherein said list or a portion thereof is generated prior to said step of encoding.

12. The method according to claim 8 further comprising the step of block mapping, in which every block, or a reference thereto, associate with a pre encoded primitive is placed in a macro block map.

13. The method according to claim 12 wherein said step of merging further comprises encoding and merging of dynamic regions into said output stream.

14. The method according to claim 13, wherein the step of encoding said dynamic region and the step of macro block mapping are carried on simultaneously.

15. The method according to claim 8 wherein said graphics primitive comprise text characters.

16. The method according to claim 8 wherein said source video frame is generated by a computer.

17. The method according to claim 8, wherein said pre-encoded graphic primitives are readable by a computer and wherein said computer merges said primitives into said source video frame.

18. The method according to claim 8 wherein said output video stream comprises an MPEG-2 stream.

19. The method according to claim 18, wherein said step of merging further comprises the step of creating an MPEG 2 slice prior to merging a pre-encoded primitive.

20. A method for efficient encoding of video frames comprising the steps of:
pre-encoding graphic primitives into a pre-encoded data store;
determining portions of a source video frame which correspond to pre-encoded primitives;
encoding said source video frame or a portion thereof into an output video stream;
wherein said step of encoding comprises the step of merging said pre-encoded primitive data from said pre-encoded data store into said output video stream.

21. The method according to claim 20 wherein said step of encoding further comprises encoding and merging of dynamic regions into said output stream.

22. The method according to claim 20 wherein said graphics primitive comprise text characters.

23. The method according to claim 20 wherein said source video frame is generated by a computer.

24. The method according to claim 20, wherein said pre-encoded graphic primitives are readable by a computer and wherein said computer merges said primitives into said source video frame.

25. The method according to claim 20 further comprising the step of, making a list of pre-encoded primitives and their location within the source video frame, and then utilizing the list during the encoding process to merge the primitives as indicated by the list.

26. The method of claim 25 wherein said list comprises references to blocks comprising graphic primitive data.

27. The method according to claim 20 wherein said source video frame is generated by a computer.

28. The method according to claim 20 wherein placeholders are located in the source video frame to indicate desired pre-encoded primitive replacement.

29. The method according to claim 20 wherein said source video frame is a representation of a computer generated image containing text, and wherein said text, or portions thereof are replaced by pointers to said pre-encoded primitives.

30. The method according to claim 20 wherein said source video frame comprises a portion of an animation sequence.

31. The method according to claim 20 wherein at least one of said pre-encoded primitives represents a banner.

32. The method of claim 20 wherein said output video stream comprises an MPEG-2 stream.

33. The method of claim 32 wherein said step of merging further comprises the step of creating an MPEG 2 slice prior to merging a pre-encoded primitive.

34. A method for efficient encoding of computer generated video frames into an output stream, the method comprises the steps of:
pre-encoding graphic primitives into a pre-encoded data store, said pre-encoded data store comprising a plurality of macro blocks representing one or more pre-encoded primitives;
generating a list of pre-encoded primitives and relative locations thereof within a source video frame;
encoding said source video frame or a portion into an MPEG 2 compatible output video stream;
said step of encoding comprises:
mapping of blocks or references thereto, representing selected pre-encoded primitive data, and dynamic regions data, in accordance with said list, into a macro block map;
merging a plurality of pre-encoded blocks data from said pre-encoded data store, into an output video stream, as dictated by said macro block map.

35. The method according to claim 34 wherein said step of merging further comprises the step of creating an MPEG 2 slice prior to merging a pre-encoded primitive.
